(19) United States
(12) Patent Application Publication
(10) Pub. No.: US 2013/0176871 A1
(43) Pub. Date: Jul. 11, 2013

(54) Network Bottleneck Management

(71) Applicants: Åsa Bertze, Spanga (SE); András Rácz, Budapest (HU); András Veres, Budapest (HU)

(72) Inventors: Åsa Bertze, Spanga (SE); András Rácz, Budapest (HU); András Veres, Budapest (HU)

(73) Assignee: TELEFONAKTIEBOLAGET L M ERICSSON (PUBL), Stockholm (SE)

(21) Appl. No.: 13/515,338

(22) PCT Filed: Dec. 21, 2009
(86) PCT No.: PCT/EP09/67695

§ 371 Date: Jul. 16, 2012

(51) Int. Cl. H04W 24/08

(52) U.S. Cl. CPC H04W 24/08
USPC 370/252

(57) ABSTRACT

The invention provides a method by which a network element in a telecommunications network can report factors that have limited the performance of a UE in an observation period. A bottleneck score is calculated for each factor, the bottleneck score providing a measurement of the extent to which that factor has limited the performance of that UE compared to other factors in the observation period A data record for the UE is populated with the bottleneck scores and sent in a report towards upper layer management functions. When these reports are received (e.g. by a MME) they may be complemented with global entities of the users and aggregated measures created. The bottleneck scores may be calculated by collecting per-UE performance counters from a radio scheduler and estimating an actual UE performance from the collected performance counters, replacing one or more of the measured performance counters with a hypothetical value reflecting a particular factor operating ideally, and estimating a theoretical user performance based on the hypothetical value and remaining performance counters, and assigning a bottleneck score for that factor by comparing the estimated actual user performance with the estimated theoretical user performance.

### TECHNICAL FIELD

The present invention relates to a mechanism for managing bottlenecks in telecommunications networks. In particular, the invention relates to mechanisms for calculating and reporting the presence and extent of bottlenecks.

### BACKGROUND

Long Term Evolution (LTE) is a communication network technology currently under development by the 3rd Generation Partnership Project (3GPP). LTE requires a new radio access technique termed Evolved Universal Terrestrial Radio Access Network (E-UTRAN), which is designed to improve network capacity, reduce latency in the network, and consequently improve the end-user's experience. System Architecture Evolution (SAE) is the core network architecture for LTE communication networks.

Referring to FIG. 1, the LTE/SAE architecture includes a Mobility Management Entity (MME) 1, which is responsible for control signalling. An SAE Gateway (SAE-GW) 2 is responsible for the user data. The SAE-GW 2 consists of two different parts, namely a Serving Gateway that routes user data packets, and a PDN Gateway that provides connectivity between a user device and an external data network. These nodes are described in detail in 3GPP Technical Specification (TS) 23.401. All these nodes are interconnected by an IP network. Further nodes are the eNodeBs 3, 4, which act as base stations in the network. There are three major protocols and interfaces between these node types. These are S1-MME (between the eNodeBs 3, 4 and the MME 1), S1-U (between the eNodeBs 3, 4 and the SAE-GW 2, or more correctly between the eNodeBs 3, 4 and the Serving Gateway), and X2 (between eNodeBs 3, 4). The corresponding protocols used in these interfaces are S1AP (S1 Application Protocol) and X2AP (X2 Application Protocol). All these protocols and interfaces are IP-based. In addition, the network may contain other nodes that are part of the above interface, for example a Home eNodeB Gateway (HeNB GW) between a HeNB and rest of the nodes in the network.

In all new generation mobile systems the amount of resources allocated to a user are decided dynamically taking into account many factors including the radio quality, congestion level, capacity limits, QoS parameters. As a result, the observed performance for a user changes in time over a wide range. Using current technology, it is a very difficult task to identify the problems related to the resource allocation, and identify exactly how subscribers are impacted by the different factors. Without such reliable management capability, the efficient operation of the network is quite limited and operators have to rely on more indirect methods.

Subscriber and equipment tracing enables network operators to collect statistics on given terminals, or User Equipments (UEs) across the system. This is supported by 3GPP TS 32.421 v8.5.0 (June 2006). “Objective quality measures” UE reporting is under standardization in 3GPP. This type of reporting can be switched on to gain information about service quality as seen by the UE.

Nodes implement performance counters to monitor the performance of node functions. For example, in LTE eNodeBs are planned to contain scheduler related counters. These counters contain average values for all UEs reported periodically.

The measured data can be processed with generic statistical methods, such as multivariate data analysis, factor analysis, which helps to find the relation between certain input variables (i.e., factors) and some output measures or component analysis, which tries to explain the source of variance in the measured data. Another related technique is sensitivity analysis, which is a method to evaluate the “goodness” of a mathematical model of a given system by quantifying the uncertainty of the results obtained with the model in case some input parameters change as compared to what has been assumed. This evaluates how reliable the results are compared to the particular model, and as such it is not particularly appropriate for identifying the bottleneck factors limiting the performance of a particular user.

Thus it can be seen that many network management actions or self-organizing functions require detailed information from the network, and this can be difficult to obtain.

In particular, UE or subscriber tracing (as detailed in TS 32.421) requires certain UEs to be identified in advance, and measurement can be carried out only for a limited time and for a limited amount of UEs. This is because the trace is very detailed, and it is not feasible to switch it on for all subscribers all the time. This function is suitable for troubleshooting, when a set of certain known UEs are traced, but not for network management purposes. UE tracing also does not specify how to report node internal performance metrics in a coherent standard way.

Performance reports directly from the UE provide valuable information about the performance for UEs but it does not contain further information about bottlenecks: only the quality experience of the UE itself is reported.

Counters can be specified but they are not on per-UE level, so efficient per-UE action or advanced Self-Organising Network (SON) algorithms are not possible. The averaged view provided by counters does not make it possible to make correlations between factors. Moreover, it is not obvious what factors need to be measured and reported from the network that can be used for bottleneck identification.

It is not currently possible to calculate and report the reasons for bottlenecks impacting on individual UEs. Generic statistical methods cannot easily be applied to this problem, since with these methods the detailed per-UE data remains hidden and in any event the identification of per-UE bottlenecks would be difficult to achieve.

Similarly, finding the relationship between certain input parameters and the measured output, i.e., to find a model of the system and then evaluate it, as it is done by sensitivity analysis, does no assist in identifying per-UE bottlenecks.

Furthermore, modelling of the radio resources is a difficult task. There is no general model for the relations between the input parameters and performance, since this relation is highly non-linear, and there may be differences in the way nodes implement the standards.

### SUMMARY

The object of the present invention is to alleviate the above problems.

Rather than focussing on the statistical processing of measured user performance data, it has been realised that it would be desirable to investigate what the performance of a UE would have looked like if one or more circumstances had been different in a particular realization. This information can then be used to determine the bottleneck impact of particular system factors on user performance.

In accordance with one aspect of the present invention there is provided a method for a network element in a telecommunications network to report factors that have limited the performance of a UE in an observation period. A bottleneck score is calculated for each factor, the bottleneck score providing a measurement of the extent to which that factor has limited the performance of that UE compared to other factors in the observation period. A data record for the UE is populated with the bottleneck scores and sent in a report towards upper layer management functions.

The network element may be a base station such as an LTE eNodeB. The factors reported may be one or more of radio quality, capacity contention, UE capability and subscription limiting, and system capabilities and licensing limitation.

This makes it possible to calculate and send information about the main bottleneck reasons of UEs. This can be done by inspecting the scheduler of the radio resource on a per UE level and estimating the level of bottleneck for the most important factors such as radio, congestion, capability and capacity. The status of the scheduler can be inspected for each UE and counters are maintained on a per-UE level. Only a few key reasons for bottleneck need be collected to keep the reporting size feasible. The reports may be continuously active for all users, or may be configured for a subset of users by OAM means.

In one embodiment, the invention further provides a method of facilitating management of a telecommunications network. The method comprises receiving reports from network elements generated using a method as described above. Each report is complemented with a global identity of the user and with any other user and cell information not available in the network elements. Aggregated measures are created from the reported bottleneck scores to be used for service assurance, customer care and/or network capacity management.

The step of complementing the reports with global identities of the users may be carried out by an MME, to generate extended reports. The extended reports may be sent towards a network management node, and the aggregated measures created at the network management node

The reports may thus be collected in the network element (e.g. eNodeB) for a short period of time (e.g., 1 sec) and then transferred to the MME. The MME may adds user identity to the reports and pass them further to the OAM system. In another embodiment, the user identity may be added by the OAM system, which is then becomes the collector of eNodeB events.

The OAM system may collect the information, and can use the information for a multitude of purposes, such as invoking intelligent alarms in case of radio problems and assisting in customer care.

In accordance with another aspect of the present invention there is provided a method for calculating bottleneck scores for each of a plurality of factors potentially limiting the performance of a UE in a telecommunications network in an observation period. Per-UE performance counters are collected from a radio scheduler and an actual UE performance is estimated from the collected performance counters. One or more of the measured performance counters is replaced with a hypothetical value reflecting a particular factor operating in a non-limiting manner, and a theoretical user performance is estimated based on the hypothetical value and remaining performance counters. A bottleneck score for that factor is assigned by comparing the estimated actual user performance with the estimated theoretical user performance.

The performance counters may include counters measuring one or more of: average radio quality; distribution of the received radio quality; number of times when the UE is not scheduled due to subscription or terminal capability limitation; number of times the UE is not scheduled due to system limitation; number of times when the UE has been scheduled; number of times when there was data in a transmit buffer associated with that UE; and number of resources allocated to the UE.

In accordance with another aspect of the present invention there is provided a method for calculating bottleneck scores for each of a plurality of factors potentially limiting the performance of a UE in a telecommunications network in an observation period. A radio scheduler having a plurality of input parameters, each corresponding to a factor, is operated to allocate and monitor resources to the UE. The performance that the UE receives from the radio scheduler is measured. A virtual scheduler is operated in parallel to the radio scheduler. The virtual scheduler has the same input parameters as the radio scheduler except that one or more of the input parameters is replaced by a hypothetical value reflecting the corresponding factor operating in a non-limiting manner. The hypothetical performance that the UE would have received from the virtual scheduler with those input parameters is measured. The output of the radio scheduler is compared with the output of the virtual radio scheduler to estimate an extent to which the particular factor is a bottleneck in the user performance, and assigning a bottleneck score to that factor.

The input parameters may include one or more of: buffer status; QoS demands; radio link measurements; UE status and limitations; and system status and limitations.

The radio scheduler may be operated by a base station such as an LTE eNodeB.

The bottleneck score of a particular factor may be calculated as Score=Tput(theoretic)/Tput(actual), where Tput(theoretic) is the hypothetical throughput a UE if one or more of selected system factors had been different and Tput(actual) is the throughput that the user has actually received in the current system.

The telecommunications network may be an LTE network or WCDMA network.

The invention also encompasses a computer program product adapted to carry out any of the methods described above.

In accordance with another aspect of the present invention there is provided a base station for use in a telecommunications network. The base station comprises a downstream communications module for sending and receiving data from UEs in the network. The base station also comprises an upstream communications module for sending and receiving data upstream in the network. A radio scheduler is operatively connected to the communications modules for monitoring and allocating resources to UEs connected to the base station. A measurement unit is operatively connected to the radio scheduler and communications modules. The measurement unit is configured to measure factors that limit the performance of each UE attached to the base station, calculate a bottleneck score for each factor, the bottleneck score providing a measurement of the extent to which each factor has limited the performance of each UE compared to other factors throughout an observation period, and populate a data record for each UE with the bottleneck scores for that UE. The upstream communications module is configured to send the data record towards upper layer network management functions.

In accordance with another aspect of the present invention there is provided a computer program product comprising code adapted to be executed on a base station in a telecommunications network. The code is operable to measure factors that limit the performance of each UE attached to the base station, calculate a bottleneck score for each factor, the bottleneck score providing a measurement of the extent to which each factor has limited the performance of each UE compared to other factors throughout an observation period, populate a data record for each UE with the bottleneck scores for that UE, and send the data record towards upper layer network management functions in the network.

### BRIEF DESCRIPTION OF THE DRAWINGS

FIG. 1 is a schematic illustration in a block diagram of an LTE/SAE network architecture;

FIG. 2 is a schematic illustration of the architecture of a telecommunications network;

FIG. 3 is a flow chart illustrating a virtual throughput bottleneck analysis'

FIG. 4 is a schematic diagram illustrating the inputs and outputs of a real scheduler and virtual scheduler;

FIG. 5 is a schematic flow chart illustrating the actions carried out by a virtual scheduler;

FIG. 6 is a flow chart illustrating the steps involved in statistic based bottleneck analysis;

FIG. 7 is a schematic illustration of a base station;

FIG. 8 is a flow chart illustrating the collection and calculation of per-UE bottleneck scores;

FIG. 9 is a flow chart illustrating the aggregation of bottleneck scores to generate aggregated measures;

FIG. 10 is a flow chart illustrating the estimation of bottleneck scores using a counter-based method; and

FIG. 11 is a flow chart illustrating the estimation of bottleneck scores using a virtual scheduler.

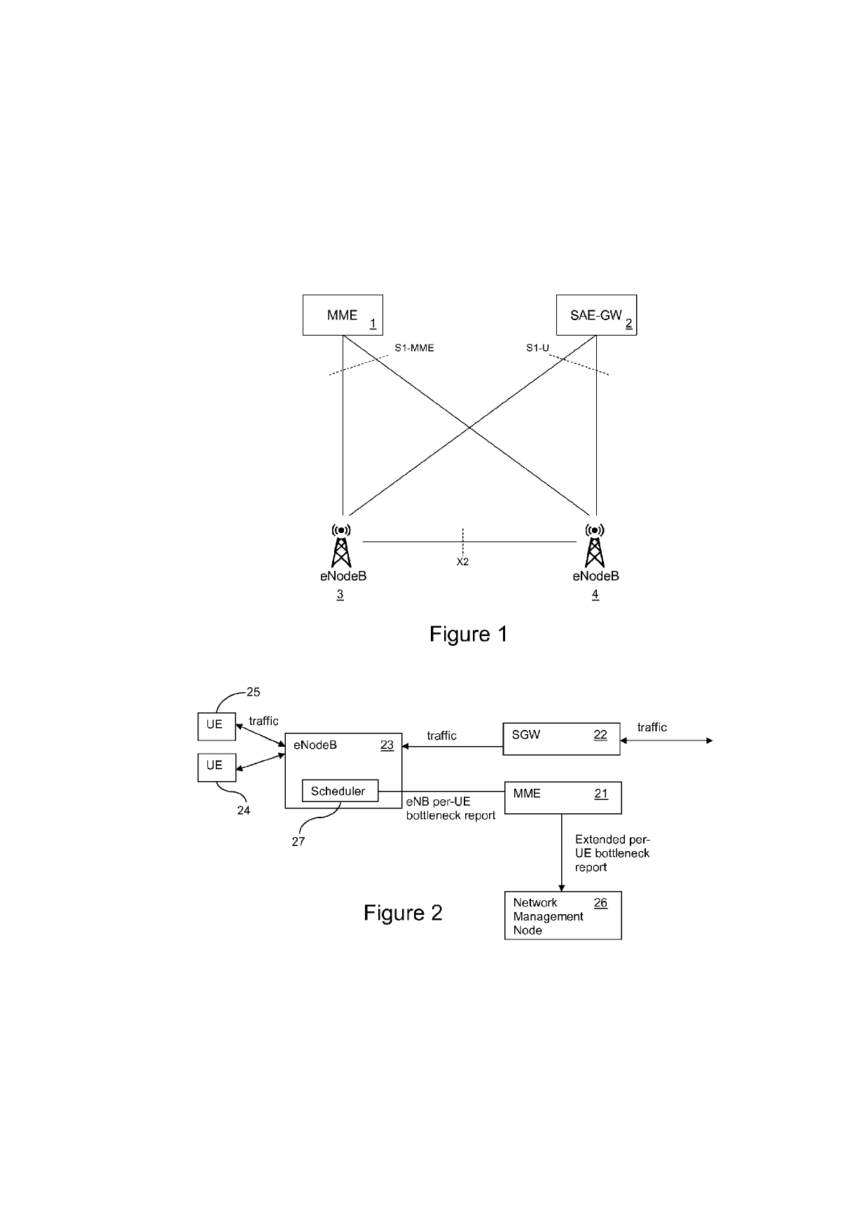

### DETAILED DESCRIPTION

FIG. 2 is a schematic illustration of the architecture of a telecommunications network. It is generally described in terms of LTE/SAE architecture, but it will be appreciated that the principles apply to Wideband Code Division Multiple Access (WCDMA) and other similar packet-based radio technologies as well.

UEs 24, 25 are connected to a eNodeB 23, which is itself connected to a MME 21. The MME 21 is connected to a Network Management Node 26. The eNodeB includes a radio scheduler 27, which is responsible for selecting UEs 24, 25 for transmission based on queue status, radio status, policies, weights etc.

In order to provide the necessary metrics for network management, the scheduler 27 is extended to keep track of each RRC-active UE 24, 25 by maintaining a per-user data record which includes a few key statistics. The key statistics are updated for each transmission or non-transmission based on a set of rules.

After the end of a reporting period, the data record for each UE 24, 25 handled by the eNodeB 23 is encapsulated in a message and sent to the MME 21 with additional information including time, local temporary identity of the user and cell location. If a session ends before the reporting period, a fragment report may be sent. This report is denoted as “eNB per-UE bottleneck report”.

The MME 21 receives the eNB per-UE bottleneck report and searches for the user's temporary identity, in order to determine the user's global subscriber identity IMSI. The MME 21 then generates an “Extended per-UE bottleneck report”, which contains the user's IMSI, identities related to the MME 21, and further user-related information stored in the MME 21. The Extended per-UE bottleneck report is sent to the Network Management Node 26.

The Network Management Node 26 receives the Extended reports from several MMEs in the network and stores the results in databases for analysis. The data assists in identifying reasons why users experience bottlenecks, and enables detailed root-cause analysis and problem localization.

Each report stores at least the following three types of data:
1. UE information;
2. UE traffic statistics; and
3. Bottleneck statistics.

These types of data are discussed in more detail below.

### 1. UE Information

UE Information includes UE identifiers, and other relevant statistics related to the location, time and bearer settings etc. over the period of the report.

In LTE, the UE information may include the following contents:
Local identifier S1 Application Port (S1AP) identity
eNB identity
Cell ID
Time of the report
E-UTRAN Radio Access Bearer (E-RAB) identity or other equivalent information (e.g. quality class indicator, maximum or guaranteed bit rates).

### 2. UE Traffic Statistics

UE traffic statistics include statistics for the current reporting period related to the amount of data received and transmitted to the user, as well as available performance measures such as for example the average throughput of the user within the reporting period.

### 3. Bottleneck Statistics

Bottleneck statistics hold information to identify key factors causing the most significant bottleneck to this particular user during a given, short reporting period. The factors reflect the main limitations which may be affecting the system, configuration, or UE. The significance of factors is represented by a numeric score. The higher the score, the more significant that factor is for the UE regarding its bottleneck status.

In a general mobile system embodiment, the key bottleneck factors are:
Radio quality factor
Capacity contention factor
UE capability and subscription limitation factor
System capabilities and licensing limitation factor

In order to determine the relevance of each potential bottleneck factor in the UE received performance (for the current reporting period), “scores” are assigned to each of these factors, where the scores can be calculated as a “virtual throughput” based score calculation, or as a statistic based score calculation. These are now discussed in more detail.

### Virtual Throughput Based Scores

The score for each factor is calculated as a ratio between the theoretical and actual throughput values:

Score=Tput(theoretic)/Tput(actual)

The actual throughput (Tput(actual)) is the throughput measured for the UE 24 during the reporting period, and is available in the traffic statistic part of the report (item (2) above). The actual throughput is measured as the size of a continuous packet burst (i.e., the amount of data sent during a queue busy period) divided by the time needed to transmit that burst.

The theoretical throughput (Tput(theroretic)) is an attempt to determine what the throughput would be if the factor under investigation was operating ideally (i.e. in a non-limiting manner). It is therefore based on some modification of the real environment by assuming that the factor in question is not a limit, while all other factors are kept unchanged. In other words, the factor under investigation is isolated from the others and assumed to be “perfect” in the calculation of the theoretical throughput.

For example, when calculating the score for the radio quality, the theoretical throughput is calculated as if the user had the same contention, capabilities etc. but, instead of the actual radio quality, the eNodeB would assume a certain, pre-defined good radio quality.

The theoretical throughput for the capacity contention factor is calculated by considering the radio quality as measured, but assuming that no contending UEs are present in the cell during the time period.

The theoretical throughput for the UE capability and subscription limitation factor is calculated assuming the UE is limited by neither its capability nor its subscription.

The theoretical throughput for the system capabilities and licensing limitation factor is calculated assuming no system limitation of these kinds.

It is an important feature of these scores that they calculate a “tangential” behavior of the system, that is the small scale behaviour as a result of a certain change. This is sufficient to evaluate the actual bottlenecks, but it cannot evaluate the impact of the next appearing bottleneck once the first one has been eliminated.

There are at least two methods which can be used to calculate the virtual throughput:
Counter based method
Virtual scheduler method

### Counter Based Method

In the counter based method, several counters are collected in the scheduler 27 for each UE 24, 25. Suitable counters include:
average radio quality (avg_cqi) or, in a more advanced implementation, the distribution of the received radio quality (distr_cqi)
number of times when the UE is not scheduled due to subscription or UE capability limitation (count_ue_cap),
number of times the UE is not scheduled due to system limitation (count_sys),
number of times when the UE has been scheduled (N_scheduled)
number of times when there was data in the transmit buffer associated with that UE (N_data_in_buffer),
number of resources allocated to the user (num_prb). The number of resources in LTE system is preferably the number of Physical Resource Blocks (PRBs).

Where the network is an LTE, the calculation for the different bottleneck scores can be done in the following way:

Radio quality score=Rate_ue(good CQI)*num_prb*1/(Δ*N_data_in_buffer)/Tput(actual), (Eqn.1.)

where Rate_ue(cqi) denotes the number of bits that can be carried by one PRB given a radio link quality of cqi and the capability of the given UE (e.g., in terms of supported modulation scheme) and Δ is the length of the scheduling interval (i.e., 1 ms in case of LTE).

It will be noted that the impact of improved channel condition on the scheduler behavior cannot be taken into account in this formula. In other words, it is not considered whether the scheduler would have selected this UE more often if it had had a better radio quality.)

In the calculation of the capacity contention score the system assumes that, during those scheduling instants when the UE or system was not limited, the user could have occupied all physical resource blocks:

Capacity contention score=(Rate_ue(avg_cqi)*total_number_prb*(N_data_in_buffer−count_sys−count_ue_cap)+(count_sys+count_ue_cap)*Tput(actual))/(Δ*N_data_in_buffer)/Tput(actual), (Eqn.2.)

where total_number_prb includes the total number of PRBs available for user data during one scheduling interval.

UE capability and subscription limitation score=(Rate_max(avg_cqi)*num_prb/N_scheduled*(N_data_in_buffer−count_sys)+count_sys*Tput(actual))*1/(Δ*N_data_in_buffer)/Tput(actual), (Eqn.3.)

where Rate_max(cqi) denotes the number of bits that can be carried by one PRB given a radio link quality of cqi and no capability limitation of the given UE. (Note that num_prb/N_scheduled gives the average number of PRBs allocated to the UE when scheduled.)

System capabilities and licensing limitation score=(Rate_ue(avg_cqi)*num_prb/N_scheduled*(N_data_in_buffer−count_ue_cap)+count_ue_cap*Tput(actual))*1/(Δ*N_data_in_buffer)/Tput(actual) (Eqn.4.)

It will be appreciated that the calculations described above are examples, and other formulae may be used as well.

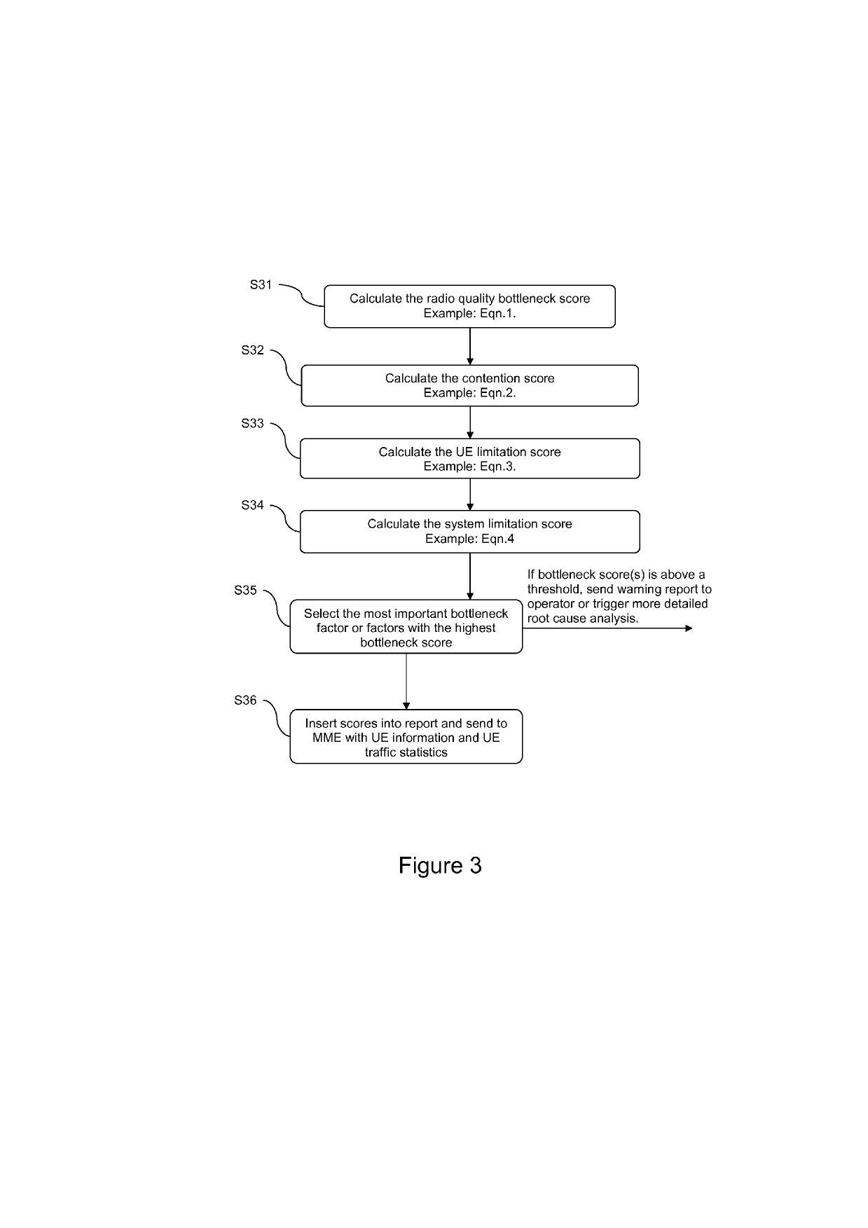

FIG. 3 is a flow diagram illustrating the virtual throughput based bottleneck analysis method, using counters for bottleneck score calculation. In steps S31-S34, scores are calculated for each of the key bottleneck factors. In step S35, the most important bottleneck factor (or the factors with the highest score) is selected. If this score (or these scores) is selected, a warning report is sent from the eNodeB 23 to the operator to identify the bottleneck. In step S36 the scores are inserted into a report along with the UE information and traffic statistics and sent to the MME 21 as described above.

### Virtual Scheduler Method

A virtual scheduler method may be used instead of the counter based method to calculate the virtual throughput, and can provide more accuracy. A virtual scheduler algorithm is run by the eNodeB 23 for each UE 24, 25 independently. The virtual scheduler operates in the same way as the real scheduler 27, except that decisions made by the virtual scheduler do not result in data transmission, but are used solely for bottleneck analysis. The virtual scheduler is also different from the real one in that it uses modified input data depending on which bottleneck score it is calculating.

However, it will be appreciated that the purpose of the virtual scheduler is the same as the counters described above, namely to isolate the bottleneck factors and calculate a theoretical throughput for each factor as though that factor were behaving ideally (in a non-limiting manner).

For example, in the calculation of the radio quality factor, the virtual scheduler uses artificial values for the Channel Quality Indicator (CQI) instead of the real value, e.g. corresponding to a typical “best” case radio environment.

The virtual scheduler can run in parallel with the real scheduler 27 in the eNodeB 23 and produce the virtual throughput values as output data. The virtual scheduler 47 may execute the following two main steps:

1. Based on radio link quality information, user buffer status, user bearer QoS demands, system status, UE capability limitations, the virtual scheduler selects the set of users for scheduling for the next scheduling interval and assigns resources (i.e. PRBs in case of LTE) to the selected users. This selection and resource assignment algorithm can be the same as that of the real scheduler with the difference that the virtual scheduler may assume hypothetical values for some of the input parameters.
2. Next, the virtual scheduler can simulate the virtual transmission and calculate the outcome of the transmission. For instance, it may assume Hybrid Automatic Repeat Request (HARQ) retransmissions with certain probability. In the simplest case, however, the virtual scheduler can assume that the outcome of the transmission is the same as assumed during the scheduling decision. For the radio link conditions of real users, the virtual scheduler may take the same radio link quality values (channel gain, interference) as seen by the actual transmissions in the real scheduler. However, it will be noted that, as the transmission in the real scheduler may not necessarily happen at the same time as in the virtual scheduler, there can be some discrepancy between the channel conditions assumed by the virtual scheduler and the channel conditions that would have been seen by a real transmission.

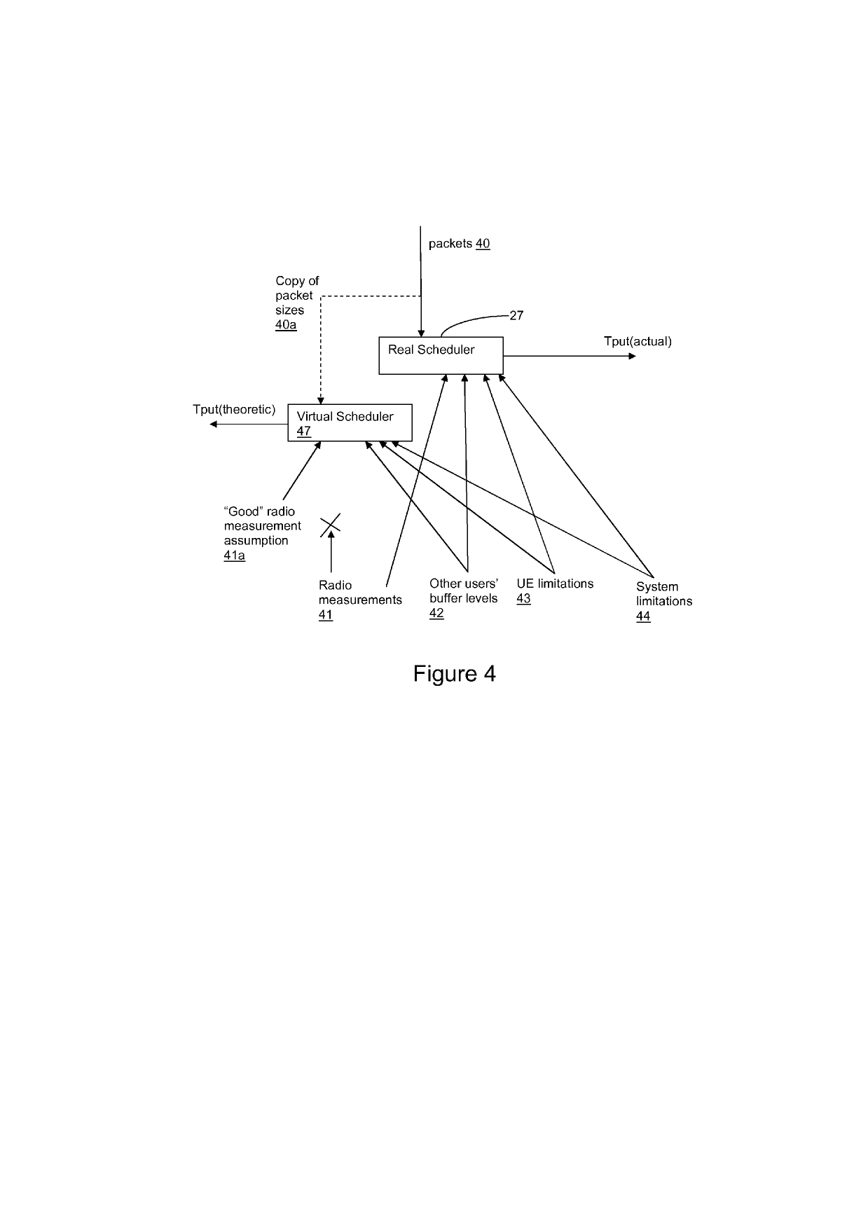

FIG. 4 is a schematic view of the inputs and outputs of a virtual scheduler 47 and real scheduler 27. In the example shown in FIG. 4, the schedulers are configured to determine a score for the radio quality factor.

In this example packets 40 are received, for example from the SGW 22 (not shown in FIG. 4), and sent to the real scheduler 27 for scheduling. A copy of the packet sizes 40a is input to the virtual scheduler 47. The real values for other users' buffer levels 42, UE limitations 43 and system limitations 44 are input into both the real scheduler 27 and the virtual scheduler 47. The real values for radio measurements 41 are input to the real scheduler 27 as usual, but are not input to the virtual scheduler 47. Instead, a “good” assumption of the radio measurement 41a is input into the virtual scheduler 47. The real scheduler 27 then calculates and exports the actual throughput Tput(actual), and the virtual scheduler calculates and exports the theoretical throughput Tput(theoretic) on the “best case” assumption for the radio environment. The score for the radio quality factor can then be determined as Tput(theoretic)/Tput(actual) as before.

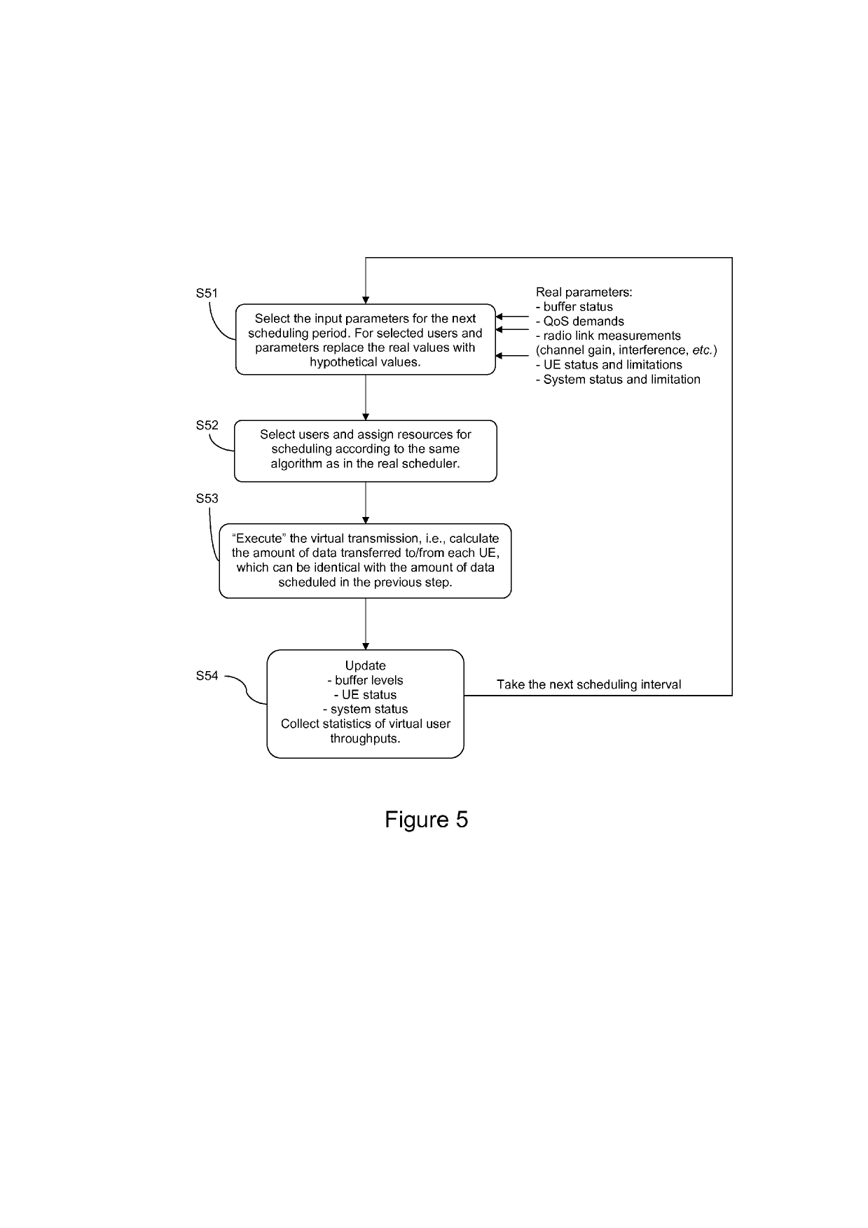

FIG. 5 is a flow chart illustrating the actions carried out by the virtual scheduler 47.

S51: The input parameters for the next scheduling period are selected. For selected users and/or parameters the real values with are replaced by hypothetical values.

S52: Users are selected and resources assigned for scheduling according to the same algorithm as in the real scheduler.

S53: A virtual transmission is “executed”, i.e., the amount of data transferred to/from each UE is calculated. This can be identical with the amount of data scheduled in the previous step.

S54: The buffer levels, UE status, system status are updated, and the statistics of virtual user throughputs are collected.

These steps are then repeated at scheduling intervals.

The virtual scheduler has the advantage that it models the working of the actual scheduler quite precisely. In principle, the same scheduling code and algorithm can be reused. Furthermore, traffic and radio link dynamics of real users are automatically taken into consideration during the score calculation. It is simple to implement and has no impact on the “real” scheduling.

It will be appreciated that a number of options are available to integrate a virtual scheduler into the system and optimise its use. For example, a virtual scheduler instance could be run for each user and for each bottleneck factor independently. This is possible to do in many cases, since the scheduler decision function, which needs to be multiplied by the number of users and factor, is usually a low-complexity function. Nevertheless, significant simplification can be achieved if only one factor and one user is analysed at a time, and the users and factors are rotated periodically. This way only a single virtual scheduler is needed.

An alternative optimisation option is that the worst performing UE (based on the real scheduler observation) is selected for virtual scheduler analysis at any given time. A yet further option is to run a virtual user as a virtual queue as part of the real scheduler. This virtual user has always data in its virtual queue and has a certain given radio quality (for example) assumed. In this option, the real scheduler handles the virtual queue the same way as all other UE queues until the decision is made. Once the decision has been made, however, no actual resources are allocated for the virtual UE, and the scheduler may choose the next-best UE for the actual transmission. In this option the UE reports contain a relative evaluation in comparison to the virtual user, which is taken as a reference.

### Statistic Based Score Calculation

As discussed above, the statistic based score calculation is an alternative to the virtual throughput based score calculation. The statistic based score calculation is also based on counters logged by the scheduler which are similar to the counters used for virtual throughput calculation. The difference is that an assessment is made of the importance of a certain factor based on its relative frequency of occurrence as a bottleneck limitation compared to other factors.

The starting point for the assessment is the relative number of cases when the UE scheduling was limited for some reason. The calculation should then determine the ratio in which different bottleneck factors have contributed to this limitation.

The set of counters may be similar to those of the previous case, including, for example, the following:
radio link quality distribution (rlq_distr);
number of times when the scheduling of the UE was restricted due to congestion, i.e. the UE has not been scheduled at all or it has been scheduled but allocated less than the required number of resources (i.e. the UE had data and all other resources available, e.g. power, capability, etc.,) (count_cong);
number of times when the scheduling of the UE was restricted due to subscription or UE capability, i.e. the UE has not been scheduled, or it has been scheduled but allocated less than the required number of resources (i.e. the subscription or UE limitation has restricted the UE from receiving more resources) (count_ue_cap);
number of times the scheduling of the UE was restricted due to system limitation, i.e. the UE has not been scheduled at all, or has been scheduled but allocated less than the required number of resources (i.e. system limitation has restricted the UE from receiving more resources) (count_sys);
number of times the UE has been scheduled (count_sched).

The different factors are taken one-by-one in a pre-determined order, and the effect of the next factor is eliminated from the overall set of scheduling limited cases in order to obtain the contribution of the given factor to the total number of UE scheduling limitation events. The order in which the factors are evaluated could be according to the priority they have on bottleneck elimination. For instance, the UE capability limitation may have the highest importance as it has to be eliminated first before addressing any of the other limiting factors. In other words, eliminating any other limiting factors will not improve the situation as long as the UE capability limitation persists.

It will be noted that this scheme may require the use of “multi-dimensional” counters (sometimes known as vector counters), which enable the counting of the joint occurrences of multiple bottleneck factors. This essentially corresponds to taking multi-dimensional distribution functions.

For example, for the joint detection of congestion and radio link quality bottlenecks, the congestion vector counter “count_cong[rlq]” could be introduced, where the dimension of the vector corresponds to the range of the radio link quality measure. For example, assume that the possible radio link quality (rlq) values are classified into three groups: good, medium and poor radio quality.

Then, the first element of the vector count_cong[1] would count the number of cases when the scheduling of the UE has been limited by congestion and the radio link quality was good at the same time, count_cong[2] counts the cases when congestion was limiting and radio link quality was medium, and count_cong [3] counts the cases when congestion was limiting and the radio quality was poor.

Other vector counters may be constructed similarly in all possible combinations, i.e. UE capability limitation in the function of radio link quality or congestion, etc. Vector counters with more than one dimension can also be constructed.

The basic principle of the statistic based method is to calculate the relative frequency of occurrence of each of the possible limitation factors based on the above counters. The factor that has the highest relative occurrence designates the most important bottleneck factor in the system. A more detailed analysis can then be performed determine the root cause for the particular bottleneck factor.

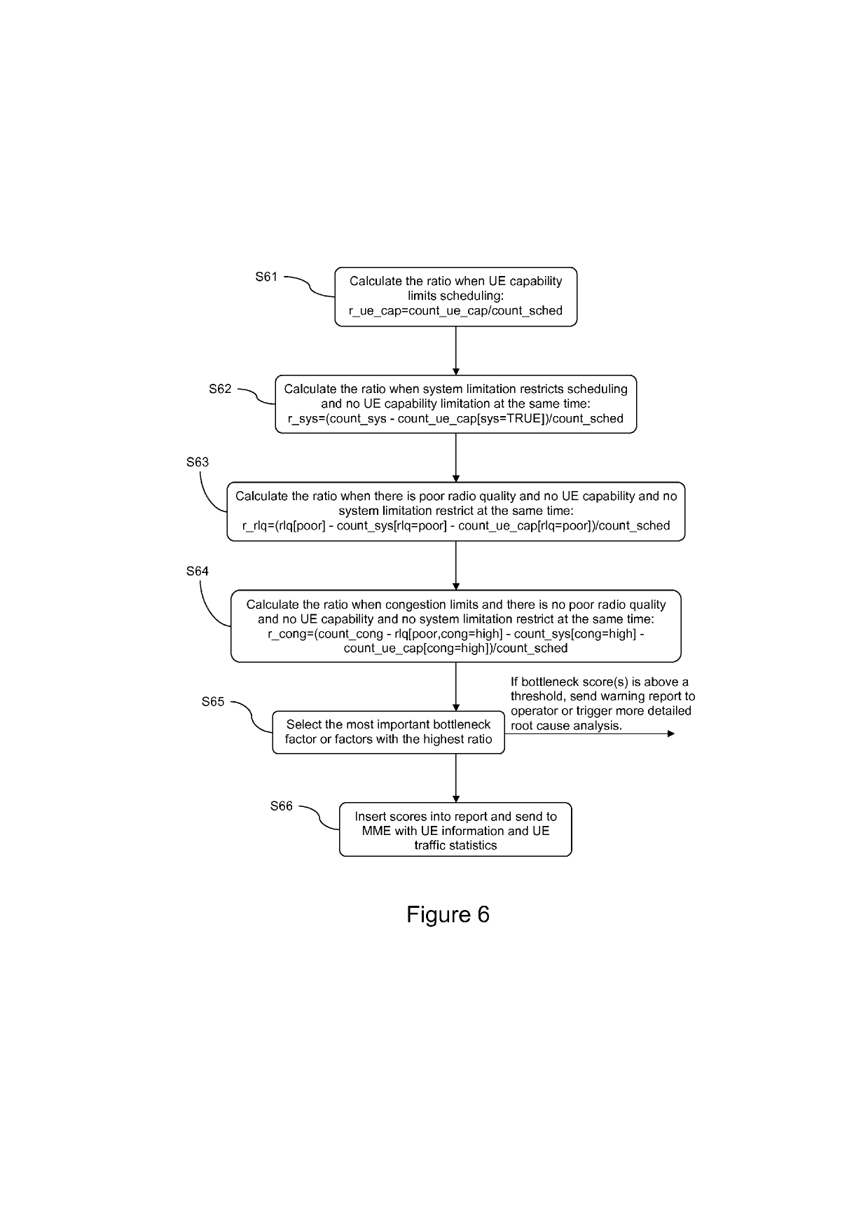

FIG. 6 is a flow chart illustrating bottleneck detection using a statistic based score calculation.

S61: The ratio when UE capability limits scheduling is calculated.

S62: The ratio is calculated when system limitation restricts scheduling and there is no UE capability limitation at the same time.

S63: The ratio is calculated when there is poor radio quality and no UE capability and no system limitation restrictions at the same time.

S64: The ratio is calculated when congestion limits scheduling, and the radio quality is not poor, and there are no UE capability or system limitation restrictions at the same time.

S65: The most important bottleneck factor (or the factors with the highest score) is selected. If this score (or these scores) is selected, a warning report is sent from the eNodeB 23 to the operator to identify the bottleneck.

S66: The scores are inserted into a report along with the UE information and traffic statistics as described above and sent to the MME 21.

### Reporting Mechanism and Report Correlation

Whichever method is used to obtain the scores, the counters are collected in the eNodeB 23 for a short period of time (e.g. 1 sec) after which the eNodeB 23 constructs a report in the format described above, and sends it towards the upper part of the network, i.e. towards the MME 21. This is necessary since the reports only hold local temporary identities (S1AP IDs). The MME 21 adds valid user identities to the reports and passes them further to the OAM system in the Network Management Node 26 for analysis.

It will be appreciated that the eNodeB can send the raw counters in the report and leave it for the upper layer nodes (e.g. in the OAM system) to perform the bottleneck identification analysis, or alternatively the eNodeB can perform the bottleneck analysis and send the results of the analysis to the upper layer nodes. The description above generally implies that the analysis is performed at the eNodeB but it will be appreciated that either approach may be used.

The OAM system collects the information, and can use the information for a multitude of purposes.

In one application, for a customer care system, the reports are collected and stored for each subscriber separately, based on IMSI or MSISDN. The customer reports may be averaged over certain time periods, e.g. for each 15 minutes. This saves storage space and allows for better presentation.

If a customer complaint arrives, the system looks-up and presents the performance bottleneck scores for the complaint period in question. Based on the averaged reports it can be verified whether the customer was experiencing radio, capacity, terminal or system limitation.

Another application, for a network and cell level bottleneck alarming system, involves the aggregation of the reports per cell and pinpointing those cells where most users are limited by the same factor. A top-N list may be presented where the bottleneck score reaches a threshold for the main bottleneck reasons including radio, capacity, terminal or system limitations. If the threshold is exceeded for a cell for a certain factor, a cell-bottleneck alarm is raised identifying the bottleneck factor.

The same statistics are also calculated for the entire network at the same time. If the network level threshold is reached, a more severe Network Bottleneck Alarm is raised.

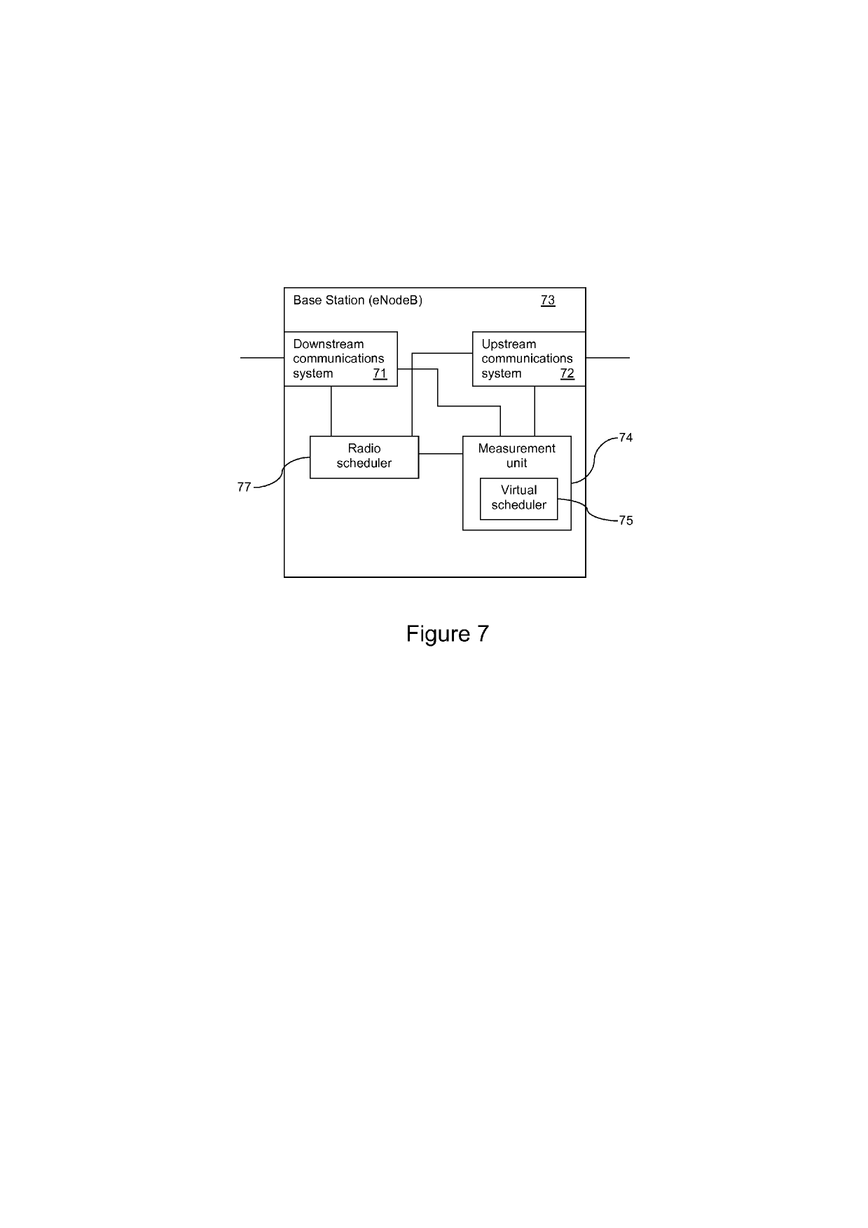

FIG. 7 is a schematic illustration of a base station (eNodeB) 73 suitable for carrying out the calculations and reports described above. The base station 73 comprises downstream and upstream communications systems 71, 72 for communicating with UEs and upstream network nodes respectively. It will be appreciated that these may be carried out by the same or different physical entities and controlled by the same or different processors running the same or different software. Both communications systems 71, 72 are connected to a radio scheduler 76 for monitoring and allocating resources to the UEs. The base station also comprises a measurement unit which is employed to monitor counters as explained in any of the methods described above, and to generate reports to be sent upstream. The measurement unit 74 may include a virtual scheduler 75 configured to operate as described above. Any of the units described may be operated by hardware or software.

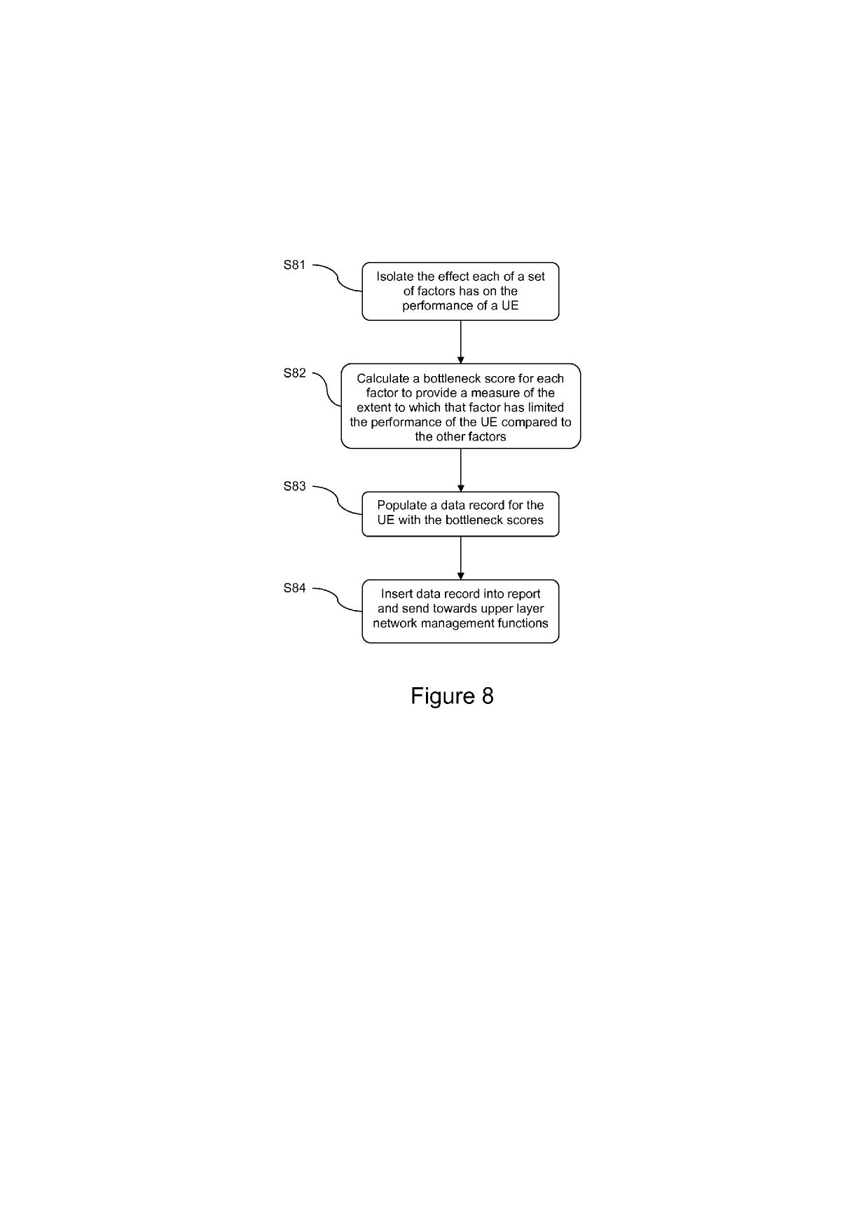

FIG. 8 is a flow chart illustrating the collection and forwarding of per-UE bottleneck scores. This will usually be carried out by a base station such as the eNodeB 23.

S81: The effect each of a set of factors has on per-UE performance is isolated (using any of the methods described above).

S82: A bottleneck score is estimated for each factor. The bottleneck score provides a measure of the extent to which that factor has limited the performance of the UE compared to the other factors in the set.

S83: A per-UE data record is populated with the bottleneck scores.

S84: The data record is inserted into a report which is sent upstream.

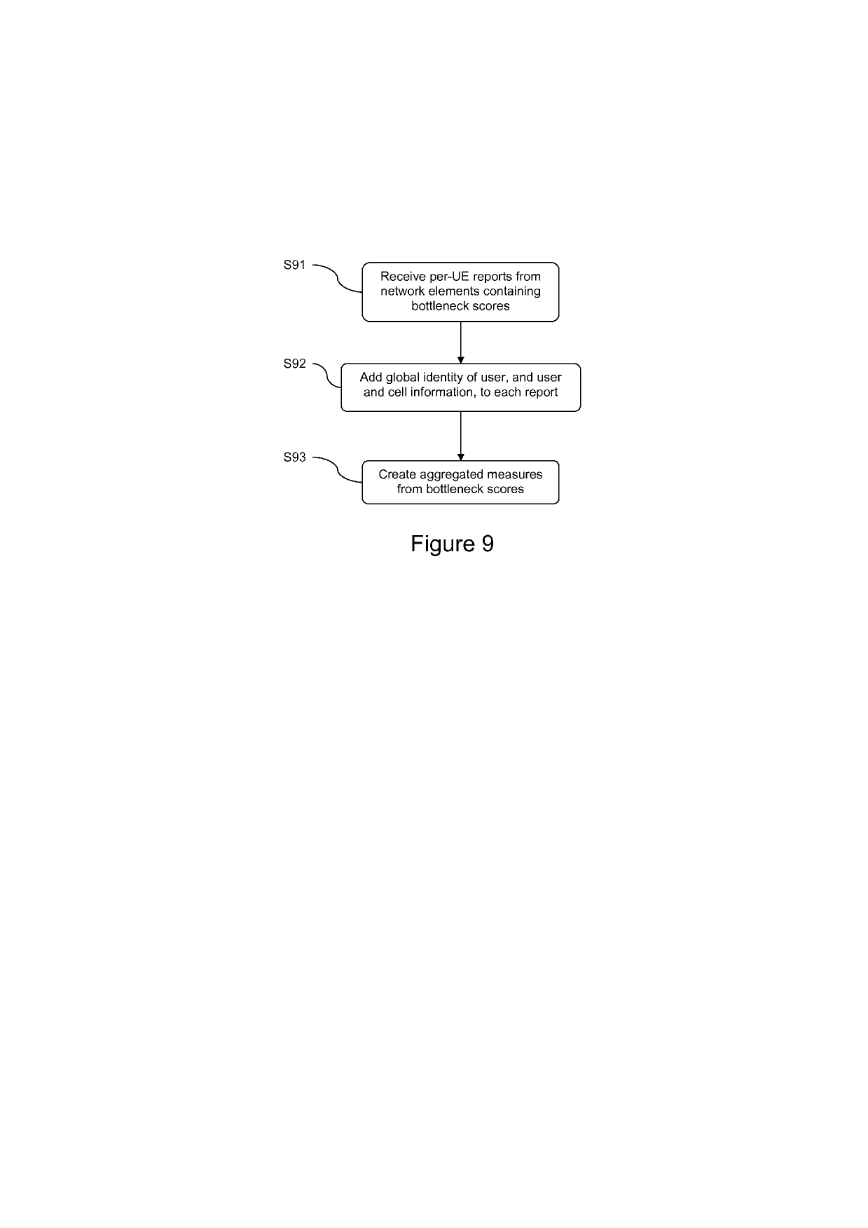

FIG. 9 is a flow chart illustrating how these reports are treated.

S91: The per-UE reports are received from network elements (base stations/eNodeBs).

S92: The global identity of the user is added to each report, together with any other user and cell information not available in the network elements which provided the reports.

S93: Aggregated measures are created from the bottleneck scores to be used for service assurance, customer care and/or network capacity management.

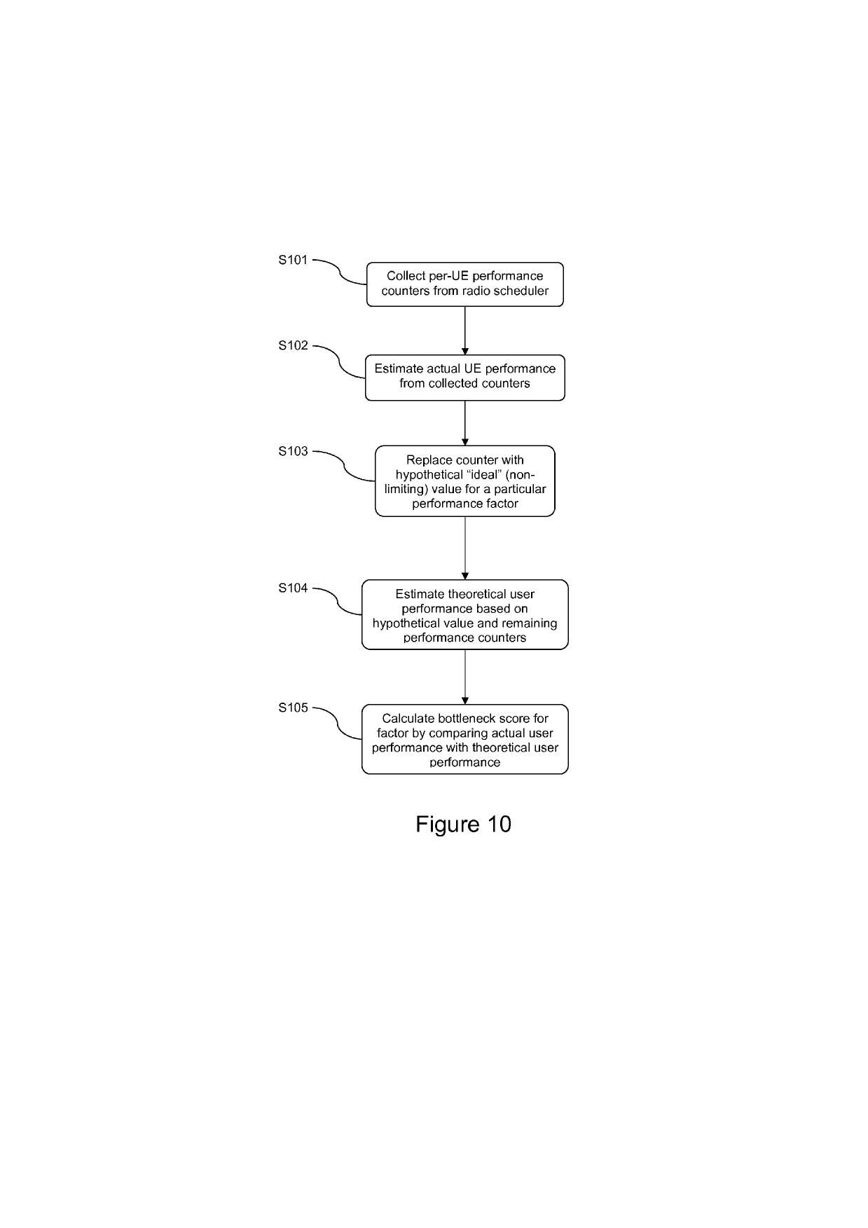

FIG. 10 is a flow chart illustrating a counter-based measurement approach.

S101: Per-UE performance counters are collected from a radio scheduler 27 of an eNodeB 23 (or other base station).

S102: The actual performance of each UE is estimated from the collected counters.

S103: One (or more) of the counters is replaced by a hypothetical “ideal” (non-limiting) value for a particular performance factor (e.g. radio quality).

S104: A theoretical performance for each UE is calculated based on the hypothetical value and the remaining (unchanged) performance counters.

S105: A bottleneck score is calculated for each factor by comparing actual user performance with theoretical user performance.

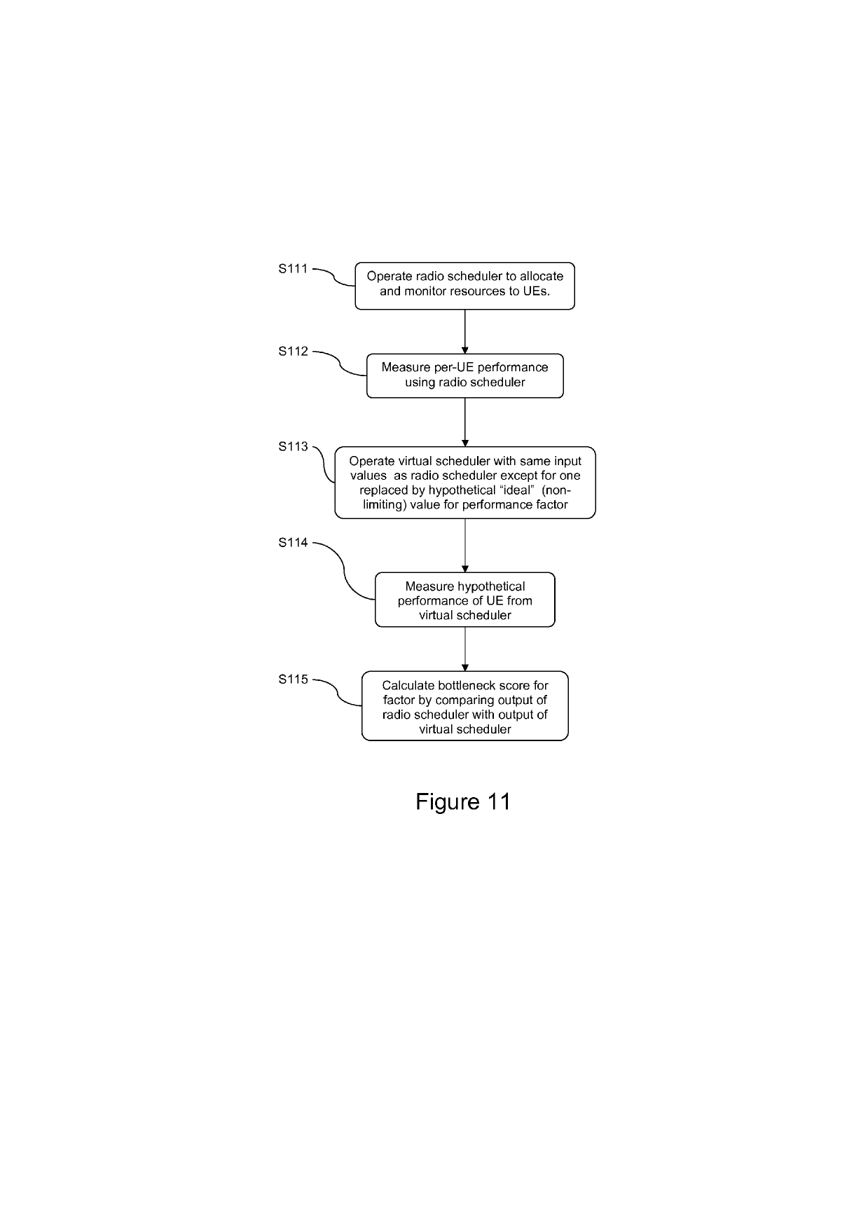

FIG. 11 is a flow chart illustrating the operation of the virtual scheduler.

S111: A radio scheduler 77 in an eNodeB 73 (or other base station) is operated to allocated and monitor resources for UEs attached to the base station. The radio scheduler has input values, some of which correspond to per-UE performance factors.

S112: Per-UE performance is measured using the radio scheduler.

S113: A virtual scheduler 75 is also operated by the eNodeB 73. The virtual scheduler has the same input values as the radio scheduler, except that one (or more) is replaced by a hypothetical “ideal” (non-limiting) value for a particular performance factor.

S114: The hypothetical performance of the UE is measured by the virtual scheduler.

S115: A bottleneck score for that factor is calculated by comparing the output of the radio scheduler 77 with the output of the virtual scheduler 75.

The mechanisms described above reduce the cost of monitoring a mobile system in several ways. They reduce the time to find performance problems, since the main bottleneck reasons are reported directly. They improve customer satisfaction and reduce churn, since the operator can see and answer customer complaints and react accordingly. They increase system utilization, since the operator can plan for a smaller head-room due to a better understanding and fast response to bottleneck types. For example, the impact of licensing limitations on customer performance is directly reported.

Furthermore, these mechanisms enable reporting of main bottleneck reasons in a concise way on a per-UE level. The reporting adds little extra complexity to the nodes.

The bottleneck factors may be evaluated by observing the inputs and outputs to the scheduler as well as the operation of the scheduler. The bottleneck factor calculation is independent of the actual implementation of the scheduler, and can therefore be suited to any scheduler implementation. The per-UE counter-based calculation method requires only simple implementation. The virtual scheduler method enables more precise evaluation with little extra complexity. The mechanisms described provide a protocol of how the reports are sent to the MME and from the MME to the Management System. The reports are correlated with local and global identities, so it is possible to identify and handle individual customer complaints as well as create new alarms pointing directly at the root-cause of performance problems.

The method and mechanisms above have been explained with reference to LTE, but it will be appreciated that they apply to WCDMA, or any other similar packet-based radio technologies.

The invention is applicable both for uplink and downlink transmissions.

1-22. (canceled)

23. A method for a network element in a telecommunications network to report factors that have limited the performance of a User Equipment (UE) in an observation period, the method comprising:
calculating a bottleneck score for each factor, the bottleneck score providing a measurement of the extent to which the corresponding factor limits the performance of the UE compared to other factors in the observation period;
populating a data record for the UE with the bottleneck scores; and
sending the data record in a report towards upper layer network management functions.

24. The method of claim 23, wherein the network element comprises a base station.

25. The method of claim 24, wherein the base station comprises a Long Term Evolution (LTE) eNodeB.

26. The method of claim 23, wherein the factors reported comprise at least one of:
a radio quality factor;
a capacity contention factor;
a UE capability and subscription limitation factor; and
a system capabilities and licensing limitation factor.

27. The method of claim 23, wherein the calculating the bottleneck scores comprises:
collecting per-UE performance counters from a radio scheduler and estimating an actual UE performance from the collected performance counters;
replacing one or more of the measured performance counters with a hypothetical value reflecting a particular factor operating in a non-limiting manner, and estimating a theoretical user performance based on the hypothetical value and remaining performance counters; and
assigning the bottleneck score to the corresponding factor by comparing the estimated actual user performance with the estimated theoretical user performance.

28. The method of claim 23, wherein the calculating the bottleneck scores comprises:
operating an actual radio scheduler to allocate and monitor resources to the UE, the actual radio scheduler having a plurality of input parameters, each corresponding to one of the plurality of factors;
measuring the performance that the UE receives from the actual radio scheduler;
operating a virtual scheduler in parallel to the radio scheduler, the virtual scheduler having the same input parameters as the radio scheduler except that one or more of the input parameters is replaced by a hypothetical value reflecting the corresponding factor operating in a non-limiting manner;
measuring the hypothetical performance that the UE would have received from the virtual scheduler with those input parameters; and
assigning the bottleneck score to the corresponding factor by comparing an output of the actual radio scheduler with an output of the virtual radio scheduler to estimate an extent to which the particular factor is a bottleneck in the user performance.

29. The method of claim 23, wherein the telecommunications network comprises a Long Term Evolution (LTE) network.

30. The method of claim 23, wherein the telecommunications network comprises a Wideband Code Division Multiple Access (WCDMA) network.

31. A method of facilitating management of a telecommunications network, comprising:
receiving reports from network elements, each report comprising a data record generated by:
calculating a bottleneck score for each of a plurality of factors, the bottleneck score providing a measurement of the extent to which the corresponding factor limits the performance of a corresponding User Equipment (UE) compared to other factors in an observation period; and
populating the data record for each UE with the bottleneck scores;
complementing each report with a global identity of a user and with any other user and cell information not available in the network elements; and
creating aggregated measures from the reported bottleneck scores to be used for at least one of service assurance, customer care, and network capacity management.

32. The method of claim 31:
wherein the complementing each report comprises complementing the reports with global identities of the users by a Mobility Management Entity (MME) to achieve extended reports;
further comprising sending the extended reports towards a network management node;
wherein the creating the aggregated measures comprises creating the aggregated measures at the network management node.

33. The method of claim 31, wherein the calculating the bottleneck scores comprises:
collecting per-UE performance counters from a radio scheduler and estimating an actual UE performance from the collected performance counters;
replacing one or more of the measured performance counters with a hypothetical value reflecting a particular factor operating in a non-limiting manner, and estimating a theoretical user performance based on the hypothetical value and remaining performance counters; and
assigning the bottleneck score for the corresponding factor by comparing the estimated actual user performance with the estimated theoretical user performance

34. The method of claim 31, wherein calculating the bottleneck scores comprises:
operating an actual radio scheduler to allocate and monitor resources to the UE, the actual radio scheduler having a plurality of input parameters, each corresponding to one of the plurality of factors;
measuring the performance that the UE receives from the radio scheduler;
operating a virtual scheduler in parallel to the radio scheduler, the virtual scheduler having the same input parameters as the radio scheduler except that one or more of the input parameters is replaced by a hypothetical value reflecting the corresponding factor operating in a non-limiting manner;
measuring the hypothetical performance that the UE would have received from the virtual scheduler with those input parameters; and
assigning the bottleneck score for the corresponding factor by comparing an output of the actual radio scheduler with an output of the virtual radio scheduler to estimate an extent to which the particular factor is a bottleneck in the user performance.

35. The method of claim 31, wherein the telecommunications network comprises a Long Term Evolution (LTE) network.

36. The method of claim 31, wherein the telecommunications network comprises a Wideband Code Division Multiple Access (WCDMA) network.

37. A method for calculating bottleneck scores for each of a plurality of factors potentially limiting the performance of a User Equipment (UE) in a telecommunications network in an observation period, the method comprising:
collecting per-UE performance counters from a radio scheduler and estimating an actual UE performance from the collected performance counters;
replacing one or more of the measured performance counters with a hypothetical value reflecting a particular factor operating in a non-limiting manner, and estimating a theoretical user performance based on the hypothetical value and remaining performance counters; and
assigning a bottleneck score for the corresponding factor by comparing the estimated actual user performance with the estimated theoretical user performance.

38. The method of claim 37, wherein the performance counters include counters measuring at least one of:
an average radio quality;
a distribution of the received radio quality;
a number of times when the UE is not scheduled due to subscription or terminal capability limitation;
a number of times the UE is not scheduled due to system limitation;
a number of times when the UE has been scheduled;
a number of times when there was data in a transmit buffer associated with that UE; and
a number of resources allocated to the UE.

39. The method of claim 37, wherein the radio scheduler is operated by a base station.

40. The method of claim 39, wherein the base station comprises a Long Term Evolution (LTE) eNodeB.

41. The method of claim 37, wherein the bottleneck score for one particular factor is calculated according to:
Score=Tput(theoretic)/Tput(actual),
where Tput(theoretic) comprises the hypothetical throughput of the UE if one or more of selected system factors had been different, and Tput(actual) comprises the throughput that the user has actually received in the current system.

42. The method of claim 37, wherein the telecommunications network comprises a Long Term Evolution (LTE) network.

43. The method of claim 37, wherein the telecommunications network comprises a Wideband Code Division Multiple Access (WCDMA) network.

44. A method for calculating bottleneck scores for each of a plurality of factors potentially limiting the performance of a User Equipment (UE) in a telecommunications network in an observation period, the method comprising:
operating an actual radio scheduler to allocate and monitor resources to the UE, the actual radio scheduler having a plurality of input parameters, each corresponding to one of the plurality of factors;
measuring the performance that the UE receives from the radio scheduler;
operating a virtual scheduler in parallel to the radio scheduler, the virtual scheduler having the same input parameters as the radio scheduler except that one or more of the input parameters is replaced by a hypothetical value reflecting the corresponding factor operating in a non-limiting manner;
measuring the hypothetical performance that the UE would have received from the virtual scheduler with those input parameters; and
assigning a bottleneck score to that factor by comparing an output of the actual radio scheduler with an output of the virtual radio scheduler to estimate an extent to which the particular factor is a bottleneck in the user performance.

45. The method of claim 44, wherein the input parameters comprise at least one of:
a buffer status;
Quality of Service (QoS) demands;
radio link measurements;
UE status and limitations; and
system status and limitations.

46. The method of claim 44, wherein the radio scheduler is operated by a base station.

47. The method of claim 46, wherein the base station comprises a Long Term Evolution (LTE) eNodeB.

48. The method of claim 44, wherein the bottleneck score of a particular factor is calculated according to:
Score=Tput(theoretic)/Tput(actual),
where Tput(theoretic) comprises the hypothetical throughput of the UE if one or more of selected system factors had been different, and Tput(actual) comprises the throughput that the user has actually received in the current system.

49. The method of claim 44, wherein the telecommunications network comprises a Long Term Evolution (LTE) network.

50. The method of claim 44, wherein the telecommunications network comprises a Wideband Code Division Multiple Access (WCDMA) network.

51. A base station for use in a telecommunications network, comprising:
a downstream communications module for sending and receiving data from User Equipments (UEs) in the network;
an upstream communications module for sending and receiving data upstream in the network;
a radio scheduler operatively connected to the upstream and downstream communications modules for monitoring and allocating resources to UEs connected to the base station; and
a measurement unit operatively connected to the radio scheduler and the upstream and downstream communications modules, the measurement unit configured to measure factors that limit the performance of each UE attached to the base station, calculate a bottleneck score for each factor, the bottleneck score providing a measurement of the extent to which each factor limits the performance of each UE compared to other factors in an observation period, and populate a data record for each UE with the bottleneck scores for that UE;
wherein the upstream communications module is configured to send the data record towards upper layer network management functions.

52. The base station of claim 51, wherein the measurement unit is configured to calculate the bottleneck scores by:
collecting per-UE performance counters from the radio scheduler and estimating an actual UE performance from the collected performance counters;
replacing one or more of the measured performance counters with a hypothetical value reflecting a particular factor operating in a non-limiting manner, and estimating a theoretical user performance based on the hypothetical value and remaining performance counters; and
assigning the bottleneck score for the corresponding factor by comparing the estimated actual user performance with the estimated theoretical user performance.

53. The base station of claim 51, wherein the measurement unit comprises a virtual scheduler wherein the measurement unit is configured to calculate the bottleneck scores by:
operating an actual radio scheduler to allocate and monitor resources to the UE, the actual radio scheduler having a plurality of input parameters, each corresponding to one of the plurality of factors;
measuring the performance that the UE receives from the radio scheduler;
operating the virtual scheduler in parallel to the radio scheduler, the virtual scheduler having the same input parameters as the radio scheduler except that one or more of the input parameters is replaced by a hypothetical value reflecting the corresponding factor operating in a non-limiting manner;
measuring the hypothetical performance that the UE would have received from the virtual scheduler with those input parameters; and
comparing an output of the actual radio scheduler with an output of the virtual radio scheduler to estimate an extent to which the particular factor is a bottleneck in the user performance, and assigning a bottleneck score to that factor.

54. A computer program product stored in a non-transitory computer readable medium for controlling a base station, the computer program product comprising software instructions which, when run on the base station, causes the base station to:
measure factors that limit the performance of each User Equipment (UE) attached to the base station;
calculate a bottleneck score for each factor, the bottleneck score providing a measurement of the extent to which each factor limits the performance of each UE compared to other factors in an observation period;
populate a data record for each UE with the bottleneck scores for that UE; and
send the data record towards upper layer network management functions in the network.

55. The computer program product of claim 54, wherein the software instructions cause the base station to calculate the bottleneck scores by:
collecting per-UE performance counters from a radio scheduler and estimating an actual UE performance from the collected performance counters;
replacing one or more of the measured performance counters with a hypothetical value reflecting a particular factor operating in a non-limiting manner, and estimating a theoretical user performance based on the hypothetical value and remaining performance counters; and
assigning a bottleneck score for the corresponding factor by comparing the estimated actual user performance with the estimated theoretical user performance.

56. The computer program product of claim 54, wherein the software instructions cause the base station to calculate the bottleneck scores by:
operating an actual radio scheduler to allocate and monitor resources to the UE, the actual radio scheduler having a plurality of input parameters, each corresponding to one of the plurality of factors;
measuring the performance that the UE receives from the radio scheduler;
operating a virtual scheduler in parallel to the radio scheduler, the virtual scheduler having the same input parameters as the radio scheduler except that one or more of the input parameters is replaced by a hypothetical value reflecting the corresponding factor operating in a non-limiting manner;
measuring the hypothetical performance that the UE would have received from the virtual scheduler with those input parameters; and
comparing an output of the actual radio scheduler with an output of the virtual radio scheduler to estimate an extent to which the particular factor is a bottleneck in the user performance, and assigning a bottleneck score to that factor.
